(19) United States
(12) Patent Application Publication
(10) Pub. No.: US 2014/0189100 A1
(43) Pub. Date: Jul. 3, 2014

(54) COMPUTING DEVICE AND METHOD OF INSTALLING HARDWARE SPECIFICATION FILES IN HOSTS

(71) Applicant: HON HAI PRECISION INDUSTRY CO., LTD., New Taipei (TW)

(72) Inventors: CHUNG-I LEE, New Taipei (TW); CHIU-HUA LU, New Taipei (TW); TSUNG-HSIN YEN, New Taipei (TW); CHIEN-CHIH LIN, New Taipei (TW)

(21) Appl. No.: 13/944,872

(22) Filed: Jul. 17, 2013

(30) Foreign Application Priority Data
Dec. 28, 2012 (TW) 101150829

(51) Int. Cl. H04L 12/26

(52) U.S. Cl. CPC H04L 43/04
USPC 709/224

(57) ABSTRACT

A method creates a plurality of host hardware specification (HHS) files for hosts with different hardware specifications, and stores the HHS files in a storage device. The method further monitors a dynamic host configuration protocol (DHCP) server and checks if the DHCP server has allocated an IP address to any new created host. If the DHCP server has allocated an IP address to a host, the method accesses the new created host based on the newly allocated IP address, and obtains a hardware specification of the host. Furthermore, the method determines an HHS file for the new created host according to the hardware specification of the host, and remotely controls the installment of the HHS file in the new created host.

### BACKGROUND

1. Technical Field

Embodiments of the present disclosure relate to cloud computing technology, and more particularly to a computing device and a method of installing hardware specification files in hosts.

2. Description of Related Art

In a process of establishing a virtualized environment, files containing hardware specifications for hosts (host hardware specification (HHS) files) need to be installed in hundreds of host computers. Presently, installation of the HHS files is repetitively performed by engineers. There is room for improvement.

### BRIEF DESCRIPTION OF THE DRAWINGS

FIG. 1 is a block diagram of one embodiment of an HHS file installation system.

FIG. 2 is a block diagram of one embodiment of function modules of the HHS file installation system in FIG. 1.

FIG. 3 is a flowchart of one embodiment of a method of installing HHS files.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

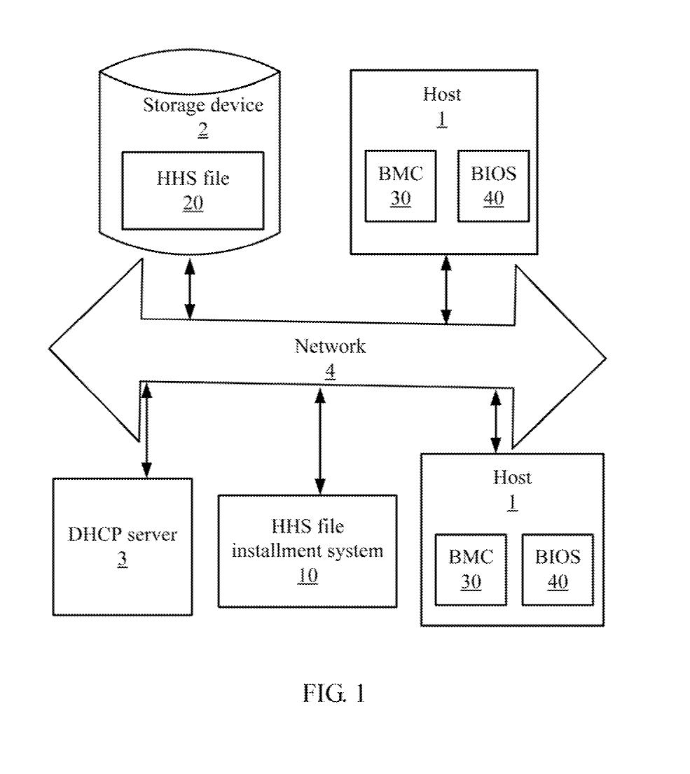

FIG. 1 is a block diagram of one embodiment of an application environment of a HHS file installation system 10 (hereinafter the “system 10”). One or more hosts 1 are electronically connected to a storage device 2 and a dynamic host configuration protocol (DHCP) server 3 via a network 4. The system 10 may be installed in each of the one or more hosts 1, or the DHCP server 3, or any other physical computing device (e.g., a server) independent from the DHCP server 3 and the one or more hosts 1.

In one embodiment, the system 10 creates HHS files 20 for hosts 1 with different hardware specifications, and stores the HHS files 20 in the storage device 2. Each host 1 includes a baseboard management controller (BMC) 30 and a basic input/output system (BIOS) 40. To configure operating systems for the host 1, an HHS file needs to be installed. An HHS file is a type of disk image composed of data contents of every written sector of an optical disc, which includes configuration information in relation to hardware components of the host 1.

The system 10 monitors the DHCP server 3. If an IP address has been newly allocated by the DHCP server 3 to any host 1, the system 10 accesses the host 1 based on the newly allocated IP address, to obtain a hardware specification of the host 1. Furthermore, the system 10 determines an HHS file 20 for the host 1 according to the hardware specification of the host 1, and installs the HHS file 20 in the host 1 by controlling the BMC 30 of the host 1.

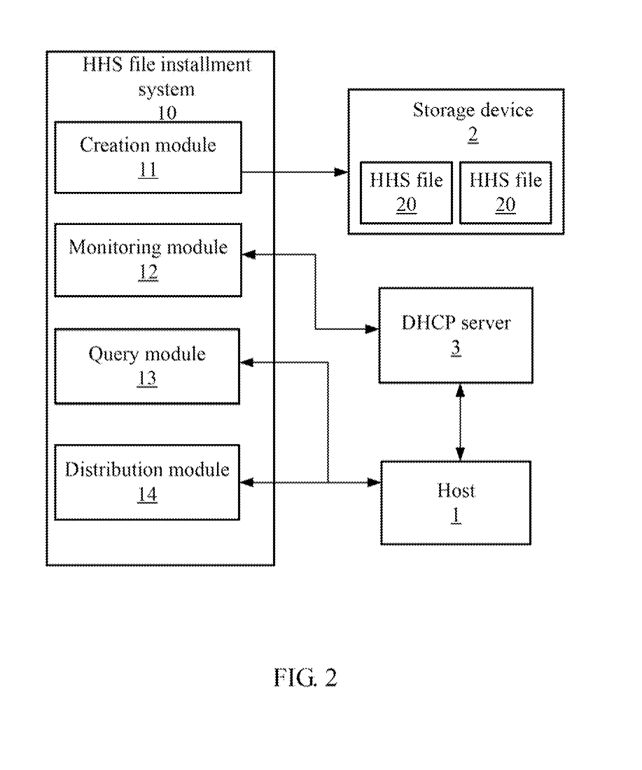

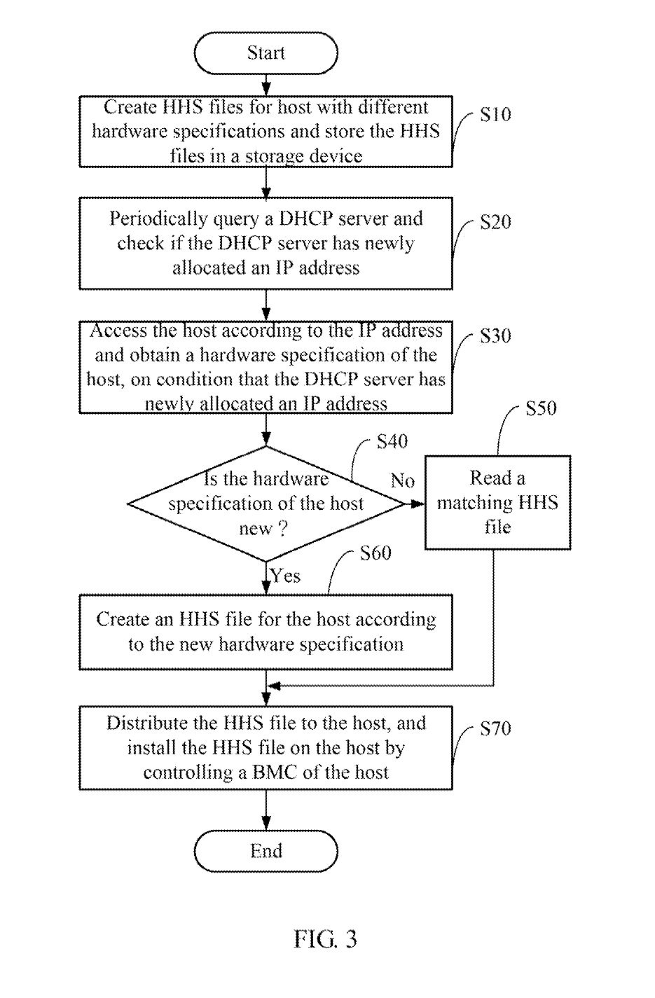

As shown in FIG. 2, the system 10 includes a plurality of function modules, such as a creation module 11, a monitoring module 12, a query module 13, and a distribution module 14. The modules 11-14 include computerized code in the form of one or more programs, which include instructions. The one or more programs may be stored in the storage device 2, or stored in a non-transitory storage device of the computing device in which the system 10 is installed. A processor of the computing device in which the system 10 is installed executes the instructions, to provide the aforementioned functions of the system 10. Detailed functions of the modules 11-14 are given in FIG. 3.

FIG. 3 is a flowchart of one embodiment of a method of installing HHS files. Depending on the embodiment, additional steps may be added, others removed, and the ordering of the steps may be changed.

In step S10, the creation module 11 creates HHS files 20 for the hosts 1 with different hardware specifications and stores the HHS files 20 in the storage device 2. A hardware specification of a host 1 includes configuration information of hardware components of the host 1. For example, the hardware specification may include central processing unit (CPU) configuration information, memory configuration information, non-transitory storage device configuration information, network card configuration information, and graphic processing unit (GPU) configuration information. The CPU configuration information may include a number of kernels of a CPU and a type of the CPU. The memory configuration information and the non-transitory storage device configuration information may include a type of memory, such as volatile or non-transitory, and storage capacities of different types of memories or storage devices. The network card configuration information may include a number of network cards, one or more interface types supported by each network card, and a speed of each network card.

According to the hardware specification of the host 1, the creation module 11 sets storage partitions of the memory of the host 1, sets a network card to take charge of communications between the host 1 and other network devices (such as the DHCP server 3 or other host 1), sets access authorities of the host 1, and packetizes the set information to generate the HHS file 20. A partition is logical division of a hard disk, so that different operating systems may be installed in the same storage device.

In step S20, the monitoring module 12 periodically queries the DHCP server 3, and checks if the DHCP server 3 has newly allocated an IP address to a host 1. When a host 1 is first connected to the network 4, the BMC 30 of the host 1 will send a request to the DHCP server 3 for an IP address.

In step S30, on condition that the DHCP server 3 has newly allocated an IP address to a host 1, the query module 13 accesses the host 1 according to the IP address allocated to the host 1 by the DHCP server 3, and obtains a hardware specification of the host 1 by querying the BIOS 40 of the host 1.

In step S40, the query module 13 determines if the hardware specification of the host 1 is in fact new by querying the HHS files 20 that are stored in the storage device 2. As mentioned above, the HHS files 20 stored in the storage device 2 are created according to the hardware specifications of the hosts 1, so that associations between the HHS files 20 and the hardware specifications of the hosts 1 can be determined according to the HHS files 20. If the hardware specification of the host 1 is not new, a matching HHS file 20 can be found from the storage device 2, in step S50, the distribution module 14 reads the matching HHS file 20 from the storage device 2, and the procedure goes to step S70. Otherwise, if the hardware specification of the host 1 is new, no matching HHS file 20 can be found from the storage device 2, and the procedure goes to step S60.

In step S60, the creation module 11 newly creates an HHS file 20 for the host 1 according to the new hardware specification, and stores the created HHS file 20 into the storage device 2.

In step S70, the distribution module 14 distributes the HHS file 20 (e.g., the matching ISO file 20 or the newly created ISO file 20) to the host 1 via the network 4, and installs the HHS file 20 in the host 1 by remotely controlling the BMC 30 of the host 1.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of a computing device, the method comprising:
creating one or more host hardware specification (HHS) files according to one or more hardware specifications of one or more hosts, and storing the one or more HHS files into a storage device;
periodically querying a dynamical host configuration protocol (DHCP) server, and checking if the DHCP server has newly allocated an IP address to a host;
on condition that the DHCP server has newly allocated an IP address to the host, accessing the host according to the IP address allocated to the host by the DHCP server, and obtaining a hardware specification of the host;
determining if the hardware specification of the host is new by querying the one or more HHS files stored in the storage device;
reading a matching HHS file from the storage device in response to a determination that the hardware specification of the host is not new, or creating an HHS file for the host according to the hardware specification of the host in response to a determination that the hardware specification of the host is new; and
distributing the HHS file to the host via a network, and remotely controlling installment of the HHS file in the host.

2. The method as claimed in claim 1, wherein the hardware specification of the host is obtained by querying a basic input/output system (BIOS) of the host.

3. The method as claimed in claim 1, wherein the hardware specification of the host comprises configuration information of a central processing unit, memory, and one or more network cards of the host.

4. The method as claimed in claim 1, wherein the storage device is a non-transitory storage device of any host or a network storage device.

5. The method as claimed in claim 1, wherein the computing device is the DHCP server or a host selected from the one or more hosts.

6. A non-transitory computer-readable medium having stored thereon instructions that, when executed by at least one processor of a computing device, cause the at least one processor to perform operations of:
creating one or more host hardware specification (HHS) files according to one or more hardware specifications of one or more hosts, and storing the one or more HHS files into a storage device;
periodically querying a dynamical host configuration protocol (DHCP) server, and checking if the DHCP server has newly allocated an IP address to a host;
on condition that the DHCP server has newly allocated an IP address to the host, accessing the host according to the IP address allocated to the host by the DHCP server, and obtaining a hardware specification of the host;
determining if the hardware specification of the host is new by querying the one or more HHS files stored in the storage device;
reading a matching HHS file from the storage device in response to a determination that the hardware specification of the host is not new, or creating an HHS file for the host according to the hardware specification of the host in response to a determination that the hardware specification of the host is new; and
distributing the HHS file to the host via a network, and remotely controlling installment of the HHS file in the host.

7. The medium as claimed in claim 6, wherein the hardware specification of the host is obtained by querying a basic input/output system (BIOS) of the host.

8. The medium as claimed in claim 6, wherein the hardware specification of the host comprises configuration information of a central processing unit, memory, and one or more network cards of the host.

9. The medium as claimed in claim 6, wherein the storage device is a non-transitory storage device of any host or a network storage device.

10. The medium as claimed in claim 6, wherein the computing device is the DHCP server or a host selected from the one or more hosts.

11. A computing device, comprising:
at least one processor; and
a storage device that stores instructions, when executed by the at least one processor, cause the at least one processor to perform operations of:
creating one or more host hardware specification (HHS) files according to one or more hardware specifications of one or more hosts, and storing the one or more HHS files into a storage device;
periodically querying a dynamical host configuration protocol (DHCP) server, and checking if the DHCP server has newly allocated an IP address to a host;
on condition that the DHCP server has newly allocated an IP address to the host, accessing the host according to the IP address allocated to the host by the DHCP server, and obtaining a hardware specification of the host;
determining if the hardware specification of the host is new by querying the one or more HHS files stored in the storage device;
reading a matching HHS file from the storage device in response to a determination that the hardware specification of the host is not new, or creating an HHS file for the host according to the hardware specification of the host in response to a determination that the hardware specification of the host is new; and
distributing the HHS file to the host via a network, and remotely controlling installment of the HHS file in the host.

12. The computing device as claimed in claim 11, wherein the hardware specification of the host is obtained by querying a basic input/output system (BIOS) of the host.

13. The computing device as claimed in claim 11, wherein the hardware specification of the host comprises configuration information of a central processing unit, memory, and one or more network cards of the host.

14. The computing device as claimed in claim 11, wherein the storage device is a non-transitory storage device of any host or a network storage device.
